(19) United States
(12) Patent Application Publication
(10) Pub. No.: US 2012/0285920 A1
(43) Pub. Date: Nov. 15, 2012

(54) Coloured Tabbed Container Closure Liners

(76) Inventors: Andrew Fenwick McLean, Reading (GB); Victor Martin Sachs, Sanderstead (GB); Craig Warren Thornhill, Thatcham (GB); Anthony Maxwell Brett, Aylesbury (GB)

(21) Appl. No.: 13/467,478

(22) Filed: May 9, 2012

(30) Foreign Application Priority Data
May 10, 2011 (GB) 1107766.6

(51) Int. Cl. B65D 41/04; B42D 15/00; B32B 38/04; B32B 37/12; B32B 41/00; B65D 53/04; B26D 7/08

(52) U.S. Cl. 215/230; 283/81; 83/14; 156/297; 156/64; 156/271

(57) ABSTRACT

A method of making and a primary laminate produced from the method including a tab used in container closure systems is provided. The laminate may be slit and punched to produce container closure liners that can be sealed to the mouth of containers. In one approach, the laminate has a colored top surface. The colored top surface of the container closure liner may be visible once the liner has been sealed to the mouth of the container.

### CROSS-REFERENCE To RELATED APPLICATION

This application claims priority from United Kingdom Patent Application Number 1107766.6, filed May 10, 2011, which is hereby incorporated herein by reference in its entirety.

### FIELD

The present disclosure relates to a method of making and to a laminate which is used in container closure systems.

### BACKGROUND

It is common place in the packaging of a wide variety of materials ranging from pharmaceutical products to instant coffee that a closure is provided in the form of a seal connected to the mouth of a container. Often the closure is such that the underside of the seal has a heat sensitive adhesive coating or a meltable plastic layer covered by a metal foil. The metal foil can provide the substrate of the seal or may include a separate substrate formed from plastic material or paper. The seal closure is placed against the mouth of the container and sandwiched against it typically by an applied screw cap or snap on cap. An induction heat process heats the metal foil and in turn activates the heat sensitive adhesive layer or melts the plastic layer so that on cooling the seal closes the mouth of the container. Alternatively, the seal may be applied to the container without the means of a cap by direct application and induction sealed in place. A snap on or screw cap can then be fitted or the seal can be accessible if required.

Containers used in the packaging industry are often provided with a screw cap so that once the seal has been opened the container can be temporarily closed again.

The caps of said containers and the containers themselves are often made out of a variety materials and are often a different colour, density or substance to each other. A difficulty encountered after the container has been emptied is that the container and cap have to be separated so that they can be recycled effectively. In many cases, the exclusion of a cap would leave just a seal laminate. In most cases this does not provide enough protection to the contents of the container as it could be easily pierced. It also eliminates the ability of the container to be temporary resealed by the cap.

In certain cases, if the cap is transparent and is formed using the same material and density as the container, then this would not be acceptable in certain industrial circumstances as the cap is often used to display instructions, a logo or be identifiable by the end user. For example, in the milk industry, the colour of the screw cap is used by the consumer to identify the grade of the product in terms of fat content.

Another difficulty often encountered by eventual users is the removal of such container closure liners from the container. Attempts have thus far been made to incorporate a tab extending side ways from the mouth of the container not within the circumference of the container so that the consumer can grip this to facilitate the removal of the container closure liner.

EP 1935636 describes a method of producing a primary laminate including a tabstock. The primary laminate comprises a seal laminate, a foil layer and a top foam layer, a tabstock and a plastic film. The method in EP 1935636 produces a primary laminate wherein the tabstock strips are visible to the end user. This makes the procedure for slitting the laminate into rolls for punching out container closure liners simple as the operator can align the slitting machinery with the visible tabstock. If the tabstock were to be obscured it would be impossible to determine where to slit the continuous sheet using the method disclosed in EP 1935636.

EP 2032460 discloses the use of coloured adhesive layer used in the formation of coloured sealing inserts for screw caps of containers. The introduction of ink into the adhesive could render these sealing inserts unsuitable as a container closure with a tabstock. The ink could decrease the strength of the adhesive layer of the primary laminate. This weakens the structural integrity of the container closures so that they are not able to be removed by pulling the tab. Instead the container closure liner would remain on the container mouth.

The method employed in EP 2032460 only provides a method for producing a sealing insert with a single, solid colour. This does not allow for a pattern or non-solid colour to be visible to the end user. EP 2032460 also highlights the difficulty of incorporating a printed top layer on a sealing insert manufactured using the same methods to produce sealing inserts having a transparent top layer. It is suggested that the production of sealing inserts with a printed top layer is uneconomical due to high printing costs and high wastage.

GB 2443185 discloses a transparent cap and visible container closure liners for use in the milk industry. The container closure liner does not have a tab. GB 2443185 describes the use of a transparent cap to overcome the problem of container closure failure not being apparent to the consumer at the point of purchase. This is easily identified by the end user through the use of transparent screw caps. There is no disclosure of a method of making such container closure liners.

### BRIEF DESCRIPTION OF THE DRAWINGS

FIG. 1 is a cross section through an example of the primary laminate including a tabstock as formed according to the method of the present disclosure of a vertical dimension greatly exaggerated.

FIG. 2 is a cross section through the screw cap container closure in place.

FIG. 3 is a perspective view showing the seal closure in place on the neck of the container.

FIG. 4 is a schematic diagram of the laminating apparatus used in the method of the present disclosure.

FIG. 5 is a perspective view of part of the apparatus illustrated in FIG. 4 with a close up view of the transparent margin and visible registration mark.

FIG. 6 is a cross sectional view through a sample of the primary laminate being subjected to the 180° C. peel test to check the strength of the extruded adhesive.

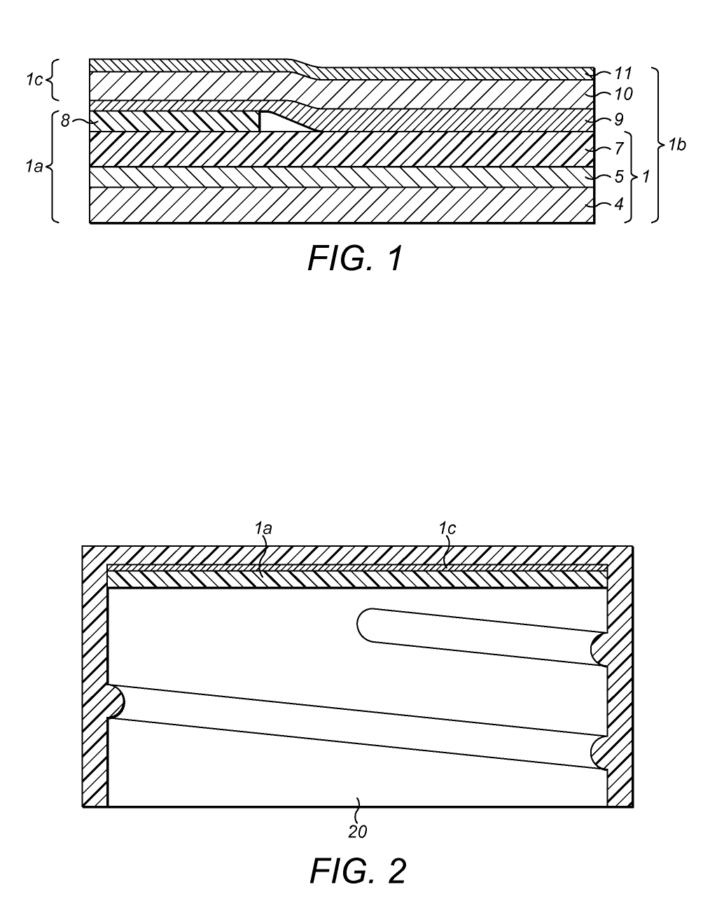

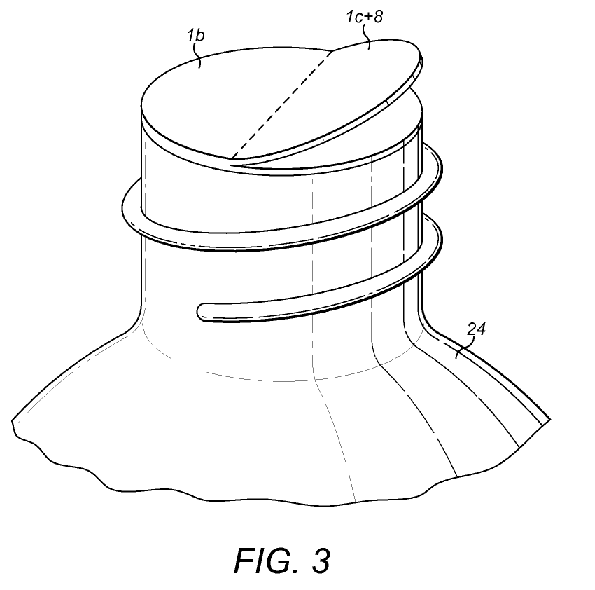

### DETAILED DESCRIPTION

An aspect of the present disclosure provides a product including (a) a container containing comestible product, (b) a container closure liner to be heat sealed around the mouth of the container, and in a preferred embodiment (c) a transparent cap, which is removable from and replaceable onto the container, characterised in that the ink pattern can be seen through the cap; and that the transparent cap is the same material and of similar density to the material used in the container.

The final product uses the ink pattern to obscure the foil and tabstock layers of the container closure and preferably the container and cap are made from the same materials so that they can be recycled together without the need to separate the cap from the container. The product and method are further illustrated in the drawings and Examples.

A second aspect of the present disclosure provides a primary laminate continuous sheet comprising (a) a seal laminate comprising a metal foil layer, a heat sealable layer and a support layer, the heat sealable layer being on one side of the foil and the support layer being on the opposite side of the foil, and (b) a tab laminate comprising a continuous plastic sheet having first and second surfaces and several strips of longitudinal continuous tabstock arranged intermittently across the primary laminate continuous sheet, wherein the tab laminate overlies the seal laminate and the tabstock is adhered to the plastic sheet on the first sheet surface, being the surface facing the seal laminate, and wherein the plastic sheet is adhered to the support layer between the tabstock strips via an adhesive, whereby the break-in value of the adhesive bond is greater than about 16 N/12.5 mm at about 330 mm/min at about 180°, characterised in that either surface of the plastic sheet carries a printed pattern of cured ink, the plastic sheet is opaque, and the printed pattern is in registration with the strips of tabstock.

By one approach, the laminate produced is a primary laminate sheet including a tab stock. The laminate has a coloured top surface. The laminate is slit and punched to produce container closure liners which are sealed to the mouth of containers. The coloured top surface of the container closure liner is visible once the liner has been sealed to the mouth of the container.

By another approach, a continuous laminate web (1b) for forming induction heat-sealable closures for containers has several strips (8) of longitudinally extending tabstock material arranged across the width sandwiched between a seal laminate substructure (1) and a continuous plastics sheet (10). The continuous plastics sheet is adhered to the facing surface of the tabstock and the top surface (7) of the seal laminate substructure suitably by an extended adhesive (9), while the tabstock is not adhered to the top surface of the seal laminate substructure. The plastics sheets is opaque and carries a printed pattern that is in register with the tabstock and the invention provides for means of aligning the tabstock with the printed pattern in carrying out the step of adhering the continuous plastics sheet to the tabstock and seal laminate, for instance by providing registration means at a margin (12) of one of the sheets, and detector means (40) for locating the registration means.

Liners for closing containers are cut from the primary laminate so as to comprise tabs lying wholly within the circumference of the, usually circular liner.

The foil and heat sealable layer of the seal laminate are conventional for induction sealing systems. The heat sealable is suitable to form an adhesive seal to a food or beverage (i.e., comestible) container.

The support layer of the seal laminate may be a plastic sheet and is selected from the group consisting polyester, preferably polyethylene terephthalate, polyamide, polypropylene or a composite, most preferably the support layer is polyethylene terephthalate.

The support layer of the seal laminate can include a foam layer. The foam may include several layers e.g. of coextruded materials having surface layers selected for compatibility with adjacent surfaces. By one approach, the foam is formed of lower alkene polymers and copolymers, such as ethylene and/or propylene. Foam formed from blended polymers may be used.

As noted above, one feature of the primary laminate is the inclusion of a tabstock so that the container closure liner will have a free tab. In the primary seal laminate produced, while the relative dimensions of the tab are not limited, in one approach, for example, the tab lies wholly within the circumference of the neck of the container onto which the liner will be attached and typically the tab occupies about 50% of the seal area, where the primary laminate has a diameter of less than about 36 mm. The tab stock may be about 10 to about 100 mm wide. The tab is provided by adhering a tab stock to the top plastic sheet of the primary laminate. The tabstock is narrower in width than the heat sealable laminate.

In one approach, the tabstock is formed of a polyester, in another approach, polyethylene terephthalate. In one embodiment of the present disclosure, the bottom surface of the tabstock which is ultimately in contact with the support layer of the heat sealable laminate may be coated with a release material, for example, silicone. This minimises the possibility, when the finished primary seal laminate is adhered to a container by induction heat sealing, of the tabstock sticking to the top support layer. Such release coatings are not typically necessary.

In one approach, the adhesive has sufficiently high surface energy to adhere to plastic materials such as PET but which will not damage the metallic rollers used. The adhesive should be of high enough peel strengths that low storage temperatures and at room temperature to avoid de-lamination of the container closure liner during removal from the sealed container using the adhered tab. The adhesive is based on a polymeric material, preferably an extrudable polymer. Materials with melt points (ASTM D3418) in the range of about 70 to about 100° C. and densities (ASTM D792) in the range of about 0.920 to about 0.955 g/cm³, for instance about 0.940 to about 0.945 g/cm³ are suitable. Copolymer of ethylene with C₁₋₂ alkyl (alk)acrylate esters (e.g., acrylate or methacrylate esters), in one approach C₁₋₄ alkyl esters, by another approach of acrylic acid, such as butyl acrylate or methyl acrylate, may be used. The copolymers are random copolymers, for instance with molar proportions of acrylates of about 0.5 to about 25%, and in one approach in the range of about 1 to about 20%. In another approach, the polymeric material has a melt flow index (ASTM D1238) of about 2 dg/min (190° C., 2.16 kg). A particularly preferred polymeric adhesive is the ethylene acrylate copolymer which has a melt flow index value of approximately 2 dg/min, a density of about 0.94 g/cm³ and a melting point of about 91° C.

The top layer of the tab laminate is a continuous plastic sheet which is made at least in part opaque by the covering ink. The covering ink can be printed so as to provide a pattern or a solid colour. In a preferred embodiment the printed plastic sheet is also coated with a lacquer when the pattern is carried on the second surface which is used to protect the ink and the printed pattern and also prevent ink from contacting the comestible product.

The printed pattern on the top plastic sheet layer should be aligned with the tabstock underneath. In one embodiment, the top sheet may have a pattern designed to provide relevant information for the consumer, e.g., “pull here,” which would need to be aligned and directly on top of the tabstock.

In one approach, the plastic sheet is formed of a material selected from the group consisting of polyester, such as polyethylene terephthalate, polyamide, polypropylene or a composite. In another approach, the plastic sheet is polyethylene terephthalate.

In one approach, the thickness of the plastic sheet is at least about 20 μm. In another approach, the thickness of the plastic sheet is in the range from about 20 to about 40 μm. In one embodiment of the present disclosure, where the plastic sheet is PET it has a surface layer with improved adhesive properties, for instance, formed by coextrusion.

A third aspect of the present disclosure provides a method of forming container closures each comprising a transparent cap for fitting around the mouth of a container and a heat sealable liner within the cap for heat sealing to the mouth, wherein the liners are cut from a longitudinally extending laminate product sheet and positioned into the cap, the laminate product sheet comprising (a) a seal laminate comprising a metal for a layer, a heat sealable layer and a support layer, the heat sealable layer being on one side of the foil and the support layer being on the opposite side of the foil, and (b) a tab laminate comprising a product plastic sheet and at least one ribbon of tabstock extending longitudinally partially across the laminate continuous sheet, wherein the tab laminate overlies the seal laminate and the tabstock is adhered to the plastic sheet on the first sheet surface, being the surface facing the seal laminate, wherein the plastic sheet is adhered to the support layer between the strips of tabstock by an adhesive wherein the break-in value of the adhesive bond is greater than about 16 N/12.5 mm at about 330 mm/min at about 180°, and wherein either surface of the plastic sheet carries a printed pattern of cured ink, the plastic sheet is opaque, and the printed pattern is in registration with at least one ribbon of tabstock, wherein the liners are cut by a punch from the product sheet through the laminate including the tabstock such that a hinged tab is formed on each liner which lies over a proportion of the perimeter of the liner and liftable from the edge of the liner to form a hinge across the liner, characterised in that the punching is aligned with the printed pattern of the cured ink, whereby the tab is visibly identifiable as a tab, and in that in the container closure the cured ink is visible through the cap when using a transparent cap.

The container to which the container closure liner is attached may be made of glass or plastic material such as polyethylene, polyester, polyvinyl chloride, polypropylene or acrylonitrile-butadiene-styrene polymer.

A transparent screw cap equipped with a container closure liner as described above may be screwed on to the open neck of a container thus sandwiching the container closure liner between the open neck of the container and the top of the cap. In one form, the screw cap is the same material, density and colour as the container. The container closure liner is then adhered via the heat sealable on the lower surface of the laminate to the open neck of the container by induction heating.

As stated previously, the method of manufacturing the primary laminate and container closure liners of the present disclosure uses the main equipment which produces previous products with minimal adaptation. The primary laminate can be made using a similar laminating station to that used in previous Application EP 1935636 (which is incorporated herein by reference) which produces a coating of adhesive extruded between the plastic film stock and the top face of the primary substrate. A problem arises in attempting to align the tabstock underlayers on the primary laminate sheet with a printed pattern on top of the plastic sheet.

The apparatus used for the method of manufacture tends to have separate unwind stations for the laminate feeds that are arranged to enable simultaneous unwinding. The laminate feeds are fed to a lamination station comprising a nip between two rollers. At this point the feeds are adhered to each other to produce the primary laminate including a tabstock. The adhesive is applied vertically downwards as a curtain into the nip where the feed rollers are in contact. The speed of the feed rollers which form the nip should be faster than the rate of application of adhesive to avoid build up of the molten adhesive in the nip which might result in an uneven coating. The adhesive is applied directly from the die head of an extruder.

Prior to reaching the laminating station, the bottom face of the tabstock and the support layer of the seal laminate are brought into contact. There is no adhesion between the two feeds. The two feeds are fed in contact with one another to the laminating station. In order to achieve this, the two feeds must approach the laminating station from the same side relative to the extruder. The combination of the seal laminate and tabstock in contact with each other is referred to as a primary substrate as they are passed to the laminating station together. As the tabstock is narrower in width than the seal laminate, the top face of the primary substrate presented to the laminating station is formed partly of the top face of the tabstock and partly of the top layer of the seal laminate. The width of this plastic sheet is the same as or a little narrower than the width of the heat sealable laminate.

Ink can be printed onto the plastic sheet so that it has been rendered opaque before the manufacture of the continuous primary laminate sheet.

The curtain of adhesive should not extend beyond the edge of the plastic sheet, and the edge portion which forms a thicker bead is collected between the edges of the plastic sheet and the support layer for trimming and removal. When pre-coated with printed ink, there is a narrow margin of uncoated PET sheet which provides means for registering the edge of the plastic sheet in order to overlay the print pattern correctly in line with the tabstock.

Registration of the printed pattern or solid colour coated plastic sheet with the prepositioned tabstock means that the manufacturing process provides a method for making closures which obscure or completely hide the tabstock.

In the laminating station, the primary substrate is brought into contact with the top plastic sheet which is fed simultaneously to the laminating station but from the opposite side of the curtain of adhesive. At the point where the top face of the primary substrate is in contact with the bottom surface of the top plastic sheet, the polymeric adhesive is continuously extruded between the two surfaces. The result is that the top plastic sheet is adhered over the entire surface area of the top face of the primary substrate. This means that over part of the width, the top plastic sheet will be adhered to the support of the seal laminate and over the remaining width, the top plastic sheet will be adhered to the top face of the tabstock. In one embodiment where the primary laminate is cut, the result is that a tab portion is formed which lies wholly within the circumference of the seal.

In one approach, the plastic sheet is corona treated on the surface which ends up as the lowermost surface in the product, this treatment taking place upstream of the laminating station. This is done in order to ensure that the bond formed to the polymeric adhesive is sufficiently strong.

In one embodiment of the manufacturing process, the feed of tabstock comprises a plurality of narrow tabstocks arranged across the machine at regularly spaced apart intervals. In this way, a continuous sheet of primary laminate including a tabstock may be formed which can then be slit as required (in line or in subsequent operations) thus improving the efficiency of the system.

The primary laminate is slit into narrower continuous strips. The slitting of the primary laminate into narrower strips needs to be done with precision in order to ensure that the cuts are made at the correct positions to produce the tabs of the required size when punched so that they are functional. These narrower strips can then be punched or cut to form a container closure liner ready to be placed in the screw cap of the container. Punching or cutting may be carried out in a procedure and/or location separate to the method of making the primary laminate. Alternatively the slit primary laminate can be used in direct application where the seal liner is punched/cut and induction sealed directly onto the container in a continuous process without the use of a cap. The primary laminate generally needs to be correctly positioned on the equipment for slitting in order that the tab within the slit tape is correctly positioned so that, when punched, the tab within the punched liner is of the correct size and correctly positioned so that the tab is consistent and the tabbed portion is appropriately located to be capable of being grabbed at the point of opening. The difficulty arises as the strips of tabstock are not visible continuously through the ink of the top plastic sheet.

In one embodiment of the method of manufacture involving slitting, one method for aligning the printed top plastic sheet and the underlying tabstock during laminating of the product uses a narrow band of transparent top plastic sheet left unprinted within the printed area. A registration strip at a fixed position relative to the tabstock ribbons/strips is laminated into the primary laminate continuous sheet.

During the laminating process the position of the printed top plastic sheet can be adjusted so that the band of clear transparent top plastic sheet aligns centrally about the registration tabbing strip. This ensures that the printed pattern aligns correctly with the hidden tabstock ribbons laminated within primary laminate.

A second method is the fitting of an optical sensor close to the point of lamination to detect the edge of the printed surface on the top plastic sheet, and via a drive system to laterally move the top plastic sheet unwind unit to control the position of the top plastic sheet, so that the band of clear transparent top plastic sheet aligns centrally about the registration tabbing strip within primary laminate.

The ability of being able to correctly position the primary laminate on the equipment for slitting relative to the slitting cutters helps to ensure that the position of the tabstock within the slit tapes is correctly positioned. During slitting the registration print edge of the printed top plastic sheet on the primary laminate is monitored by an optical sensor, and via a drive system to laterally move the primary laminate unwind unit, so that the printed pattern and the tabstock within the primary laminate are correctly aligned to the slitting cutters. This ensures that the printed pattern and tabstock are correctly positioned on the slit tapes.

The primary laminate or continuous slit strips including a tabstock maybe subsequently wound onto a final roll after slitting.

In one approach, the bond formed between the support layer of the seal laminate and the plastic film sheet must have an break-in value greater than about 16 N/12.5 mm at about 330 mm/min at about 180° when the tab formed of tabstock and plastic sheet is pulled from the seal laminate at about 90° to the longitudinal edge of the tab (which is the machine direction of the manufacturing apparatus) with an angle of separation of from the seal laminate about 180°. This is in order to ensure that when using the tab to remove the seal from a container, the tab plastic sheet remains adhered to the primary laminate upon application of a pulling force to the tab.

The peel test is suitably carried out using a Hounsfield Tensile Tester. Each test is carried out on three samples. The samples are cut from a strip about 12.5 mm wide taken across a sample of primary laminate or slit strip of sufficient size. The sample should be at least the length of the gap between two strips of tabstock. One end of the sample should be cut through the tabstock close to one longitudinal edge, allowing the tab comprising tabstock and plastic sheet to be separated from the seal laminate. The tabstock is mounted in one jaw of the Tensile Tester, with the seal laminate being fixed into the other jaw. The jaws separate at an angle of about 180°. An about 50 N load cell is utilised for the test. The apparatus is set so as to allow an extension of at least about 25 mm, with a speed of about 330 mm per minute.

The results recorded include the “break-in force”, the force required to overcome the initial resistance to tab de lamination. Subsequently the “running force” is measured, that is the force required to continue to separate the tab from the seal laminate. The running force is generally substantially constant. For the present product, the break-in force is the more important, since provided this is higher than the force required to peel the seal from the top of the container to which it is attached, the tab/plastic sheet will remain adhered to the seal as peeling starts, the force needed to continue this peeling being lower as the seal is peeled from the container.

### EXAMPLES

A primary laminate (1b) comprising a seal laminate (1) comprising a metal foil layer (5), a heat sealable layer (4), and a support layer (7). The seal laminate (1) is rolled onto the first feed roll (13) in the laminating apparatus.

The second unwind feed rollers (14) in the laminating apparatus is the source of the tabstock, which in this case, is a layer of polyethylene terephthalate (8). The width of the layer of polyethylene terephthalate (8) is typically in the range of about 10 to about 100 mm. A third feed roll (15) is loaded with the printed top plastic sheet, in this case a PET sheet (10). The thickness of the PET sheet (10) is in the range from about 23 to about 36 μm. The PET sheet (10) used is coextruded PET material with a surface layer which ensures optimal adhesion to the adjacent support layer of the seal laminate. The PET sheet (10) also carries a printed pattern layer (11) which can be on either side of the PET sheet. The ink pattern renders the PET sheet opaque apart from an unprinted transparent band. The ink layer on the second surface can be further coated with a lacquer if necessary.

The seal laminate (1), the tabstock (8) and PET stock (10) are simultaneously fed to the laminating station (6), the seal laminate (1) and the tabstock (8) are brought into contact to form a primary substrate (1a).

Ethylene methyl acrylate copolymer (9) with a melt flow index of about 2 dg/min (190° C., 2.16 kg (ASTM D1238)) is then extruded continuously as a curtain from the extruder (17) between the top face of the primary laminate (1a) and the bottom face of the PET sheet (10). The height of the die head above the nip was about 20 cm. The extrusion conditions, i.e., the weight of adhesive being extruded, its speed and extruder temperature, were such that a temperature of greater than about 200° C., for instance as much as about 250° C. is obtained at the nip for adhesion. Roller (18) is a chilled stainless steel roller, while (19) has a Teflon coated surface with Shore A hardness of about 70. The rollers (18) and (19) are moving at a speed of about 60 to about 100 m/min relative to the speed of application of the adhesive, the pressure between them selected to avoid the curtain creasing at the nip.

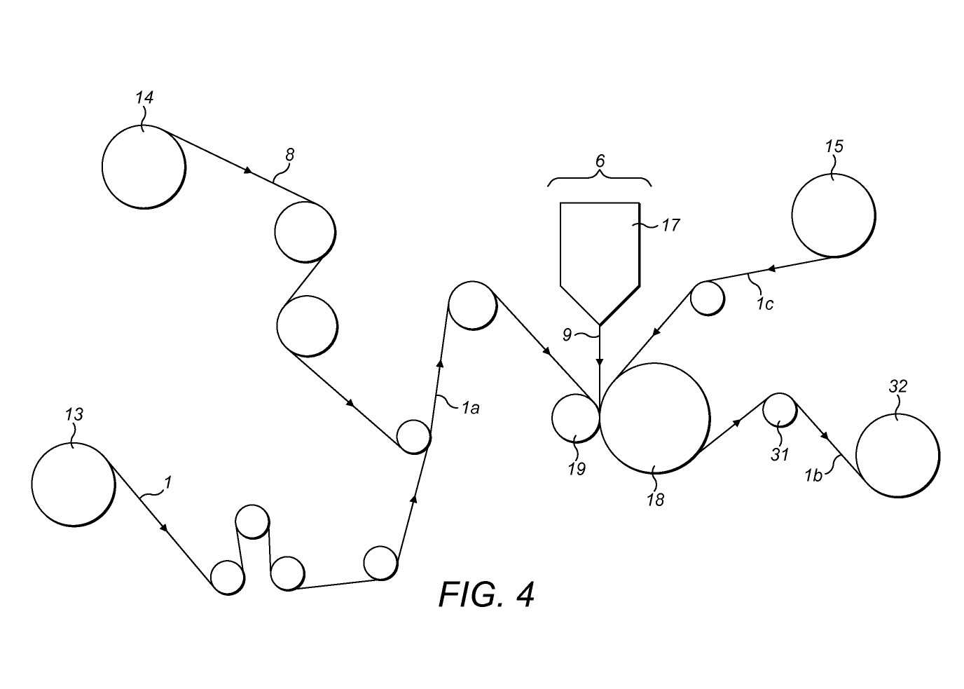

The bottom face of the plastic sheet (10) and the resulting primary laminate (1b) including the tabstock (8) is passed with the top face of the plastic sheet (10) in contact with the chilled roller (18) at a temperature of about 23° C. to be rolled onto a final product roll (32). This process is illustrated schematically in FIG. 4.

A registration tabbing strip (12a) is positioned on the primary substrate (1b) so that it can be seen through the transparent band (12b) of the top plastic sheet (1c) confirming that tabstock alignment is correct. This registration tabbing strip is relative to the position of the tabstock (8) of the primary substrate and the printed pattern (11) of the top plastic sheet. This system allows for accurate lamination of the tabstock (8) within the continuous primary laminate relative to the printed patterns of the top plastic sheet and subsequent slitting of the continuous primary laminate into rolls of primary laminate with aligned tabstock and printed patterns.

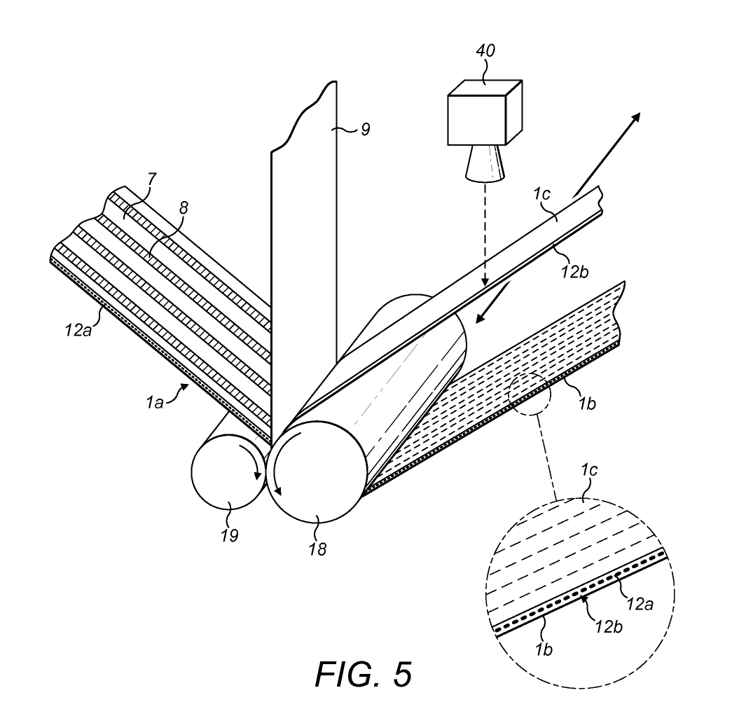

In another embodiment, an optional sensor (40) can be used to detect the edge of the printed pattern on the top plastic sheet and can control the lateral position of the top plastic sheet relative to the tabstock on the primary substrate. This can be seen schematically in FIG. 5.

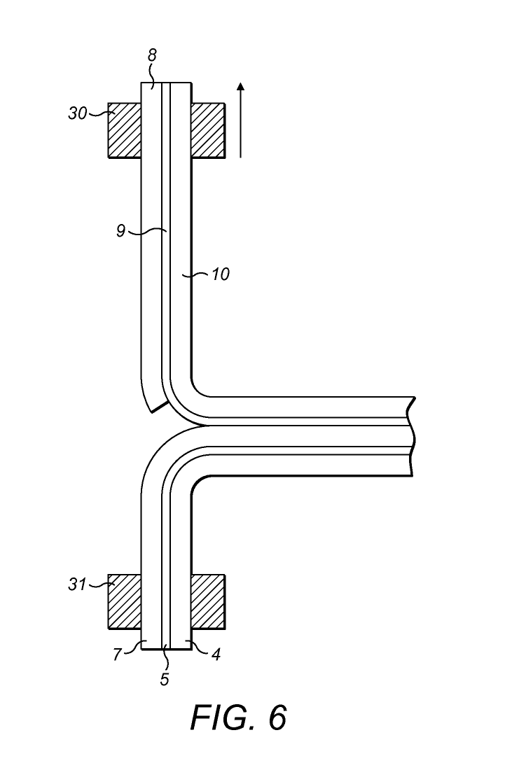

The break-in peel strength was measured as explained above and illustrated in FIG. 6. The seal laminate comprising a support layer (7), foil (5), and heat sealable layer (4) were positioned into the lower jaw (31) of the tensile tester. The plastic sheet (10), the tabstock (8), and extruded ethylene methacrylate polymer (9) were mounted in the top jaw (31). The jaws were then moved apart in the direction of the arrow, with the force required to separate the materials at an angle of about 180° being recorded. The break-in value was greater than about 16 N/cm at about 330 mm/min. The Figure is a schematic with the thickness heavily exaggerated.

The primary laminate continuous sheet (1b) was then slit into narrow strips. During slitting, the edge of the printed top plastic sheet on the seal laminate was monitored by an optical sensor, and via a drive system that laterally moved the seal laminate unwind unit, so that the printed pattern and the tabstock within the seal laminate were correctly aligned to the slitting cutters the web was slit. This ensured that the printed pattern and tabstock were corrected positioned on the slit tapes. From these slit tapes of seal laminate, seal liners were punched. The seal laminate liners were inserted inside transparent screw cap (20) which is made from the same material, is the same density and the same colour as the container. The screw cap (20) equipped with the container closure liners is then screwed onto the open neck of the bottle (24). The screw cap (20) and bottle (24) are then subjected to an induction heating process in which the foil is heated around its periphery by the induction process, which, in turn, melts the heat sealable layer (4) to bond the container closure liners to the open neck of the bottle.

It will be understood that various changes in the details, materials, and arrangements of the process, liner, seal, and combinations thereof, which have been herein described and illustrated in order to explain the nature of the products and methods, may be made by those skilled in the art within the principle and scope of the embodied product as expressed in the appended claims.

What is claimed is:

1. A primary laminate continuous sheet comprising:
a seal laminate having a metal foil layer, a heat sealable layer and a support layer, the heat sealable layer being on one side of the metal foil layer and the support layer being on the opposite side of the metal foil layer;
a tab laminate comprising a continuous plastic sheet having first and second surfaces and several strips of longitudinal continuous tabstock arranged intermittently across the primary laminate continuous sheet, wherein the tab laminate overlies the seal laminate and the tabstock is adhered to the continuous plastic sheet on the first sheet surface, being the surface facing the seal laminate, and wherein the continuous plastic sheet is adhered to the support layer between the tabstock strips via an adhesive, whereby the break-in value of the adhesive bond is greater than about 16 N/12.5 mm at about 330 mm/min at about 180°; and
either surface of the continuous plastic sheet carries a printed pattern of cured ink, the plastic sheet is opaque, and the printed pattern is in registration with the strips of tabstock.

2. A continuous sheet according to claim 1, wherein the said adhesive is provided as a continuous layer across the said first sheet surface of the plastic sheet, whereby it adheres the plastic sheet to the tabstock strips and the support layer of the laminate.

3. A continuous sheet according to claim 2, wherein the said adhesive is an extruded adhesive, preferably selected from polyethylene, polyethylene vinyl acetate, maleic anhydride/acrylate ester/polyethylene copolymer, ethylene methylacrylate copolymer and acid functional copolymer.

4. A continuous sheet according to claim 1, wherein only the second surface of the plastic sheet carries a printed pattern of cured ink.

5. A continuous sheet according to claim 4, wherein the second surface of the plastic sheet is further coated over the ink with a lacquer that prevents ink migration.

6. A continuous sheet according to claim 1, wherein only the first surface of the plastic sheet carries a printed pattern of cured ink.

7. A continuous sheet according to claim 1, wherein the plastic sheet comprises polyester, preferably PET.

8. A continuous sheet according to claim 1, wherein the support layer comprises a support layer and/or a foam layer.

9. A continuous sheet according to claim 1, wherein the material forming the plastic sheet is transparent and the plastic sheet is rendered opaque by the cured ink.

10. A continuous sheet according to claim 9, wherein the cured ink pattern extends towards each edge of the plastic sheet leaving a band of transparent plastic sheet along one or both longitudinal edges, wherein one visible tabstock strip extends under the said band, and wherein the visible tabstock provides a registration mark extending in a longitudinal direction visible through the band relative to the position of the other strips of tabstock in the primary laminate.

11. A method of making a primary laminate continuous sheet according to claim 1, wherein several strips of longitudinal continuous tabstock are arranged intermittently across a seal laminate according to claim 1, and are both laminated to the first surface of a plastic sheet, wherein the plastic sheet carries a cured printed pattern on either surface, by passing a curtain of adhesive between the seal laminate and the plastic sheet,
wherein during lamination, the position of the plastic sheet is adjusted laterally relative to the position of the tabstock so that the printed pattern is in registration with the strips of tabstock.

12. A method according to claim 11 wherein an optical sensor is positioned close to the point of lamination of the primary laminate to detect the printed pattern of the plastic sheet and adjusts the lateral position of the top plastic sheet via a drive system.

13. The method of claim 11, wherein the primary laminate is longitudinally slit to form two or more longitudinally extending product sheets by means of one or more cutters aligned in relation to the strips of tabstock, whereby each product sheet carries one or more tabstock strips.

14. A method according to claim 13, wherein the cutters are aligned by means of an optical sensor which senses a single longitudinal slitting registration mark provided on the primary laminate continuous sheet.

15. A slitting method in which a continuous sheet according to claim 10 is longitudinally slit to form two or more longitudinally extending product sheets by means of one or more cutters, wherein the continuous sheet is aligned in relation to the cutters, whereby each product sheet carries one or more tabstock strips wherein the registration mark is detected by an optical sensor passing along said registration mark.

16. A method of forming container closures each comprising a heat sealable liner for heat sealing to the mouth, wherein the liners are cut from a longitudinally extending laminate product sheet, the laminate continuous sheet comprising:
a seal laminate comprising a metal for a layer, a heat sealable layer and a support layer, the heat sealable layer being on one side of the foil and the support layer being on the opposite side of the foil; and
a tab laminate comprising a product plastic sheet and at least one ribbon of tabstock extending longitudinally partially across the laminate continuous sheet, wherein the tab laminate overlies the seal laminate and the tabstock is adhered to the plastic sheet on the first sheet surface, being the surface facing the seal laminate, wherein the plastic sheet is adhered to the support layer between the strips of tabstock by an adhesive wherein the break-in value of the adhesive bond is greater than about 16 N/12.5 mm at about 330 mm/min at about 180°, and wherein either surface of the plastic sheet carries a printed pattern of cured ink, the plastic sheet is opaque, and the printed pattern is in registration with at least one ribbon of tabstock wherein the liners are cut by a punch from the product sheet through the laminate including the tabstock such that a hinged tab is formed on each liner which lies over a proportion of the perimeter of the liner and liftable from the edge of the liner to form a hinge across the liner, wherein the punching is aligned with the printed pattern of the cured ink, whereby the tab is visibly identifiable as a tab, and in that in the container closure the cured ink is visible.

17. A method according to claim 16, wherein the container closure further comprises a cap for fitting around the mouth of a container, and wherein the heat-sealable liners are positioned within the cap.

18. A method according to claim 16, wherein the cap is transparent and the cured ink is visible through the cap.

19. A product comprising:
a container containing comestible products;
a container closure liner produced according to claim 16, to be heat sealed around the mouth of the container.

20. A product according to claim 19, wherein the product further comprises a cap, which is removable from and replaceable onto the container.

21. A product according to claim 19, wherein the cap is transparent and the ink pattern can be seen through the cap.

22. A product according to claim 19, wherein the cap is a similar thermoplastic material of a similar density and of a similar colour or transparency to the thermoplastic material used for the container.

23. A product according to claim 19, wherein the ink pattern obscures the foil and tabstock.

24. A product according to claim 19, wherein the container and cap are made from recyclable materials, preferably high density polyethylene.
